(19) United States
(12) Patent Application Publication
(10) Pub. No.: US 2023/0010203 A1
(43) Pub. Date: Jan. 12, 2023

(54) Cleaning Method and Device

(71) Applicant: Nippon Telegraph and Telephone Corporation, Tokyo (JP)

(72) Inventors: Yuichi Akage, Tokyo (JP); Takashi Sakamoto, Tokyo (JP); Yurina Tanaka, Tokyo (JP); Soichi Oka, Tokyo (JP)

(21) Appl. No.: 17/783,580

(22) PCT Filed: Dec. 20, 2019
(86) PCT No.: PCT/JP2019/050146

§ 371 Date: Jun. 8, 2022

(51) Int. Cl. B23K 26/36; B08B 7/00

(52) U.S. Cl. CPC B23K 26/36; B08B 7/0042

(57) ABSTRACT

A cleaning method involves, in a first step, emitting a first laser light toward the surface of a steel material targeted for cleaning to clean the surface of the steel material. Next, in a second step, a second laser light is emitted toward the surface of the steel material to remove an oxide layer formed on the surface of the steel material due to irradiation with the first laser light. In this step, the oxide layer formed on the surface of the steel material is removed, by emitting the second laser light at a power in a range that does not cause a new oxide layer to form on the surface of the steel material.

### CROSS-REFERENCE TO RELATED APPLICATIONS

This application is a national phase entry of PCT Application No. PCT/JP2019/050146, filed on Dec. 20, 2019, which application is hereby incorporated herein by reference.

### TECHNICAL FIELD

The present invention relates to a cleaning method and device that use a laser.

### BACKGROUND

Generally, laser cleaning is technology for cleaning surfaces by irradiating a target with output from a laser source that has been propagated through fiber and the like, and volatilizing or vaporizing surface material with laser energy or heat caused by laser absorption at the surface of the cleaning target. The configuration of a conventional laser cleaning system is shown in FIG. 8.

In this system, output from a laser light source 201 is propagated through an optical fiber 202, a laser head 203 and the like and formed into a beam 206 by a lens system of the laser head 203, and this beam 206 is scanned to irradiate a surface 132 of a steel material 131 that is targeted. Due to this irradiation, cleaning of the surface 132 of the steel material 131 is realized.

Heretofore, development of laser cleaning devices has advanced to the point where large areas can be cleaned in a short time, through condensing laser beams to enhance the energy density, through enhancing laser output, and through scanning laser beams at high speed. Laser technologies are used in various fields due to the increased output of laser devices and cost reductions following the dissemination of laser technologies in recent years. Improvement in laser beam scanning methods has also been ongoing, and research and development of laser cleaning technologies and development of applied technologies have been actively pursued against this background (see NPL 1).

The abovementioned laser cleaning system is utilized in surface treatment of targets with severe unevenness, and is used in removal of food ingredients adhering to manufacturing molds for food and the like and washing off dust and grime adhering to artworks, for example. Also, in recent years, the aging of infrastructure facilities and plant facilities has become a social problem, and together with the ongoing sharp decline in the working population has seen high expectations placed on laser cleaning technologies in terms of increasing the efficiency of “rust removal” implemented in conventional facility maintenance and developing new tools.

In conventional “rust removal”, power tools such as a disc sander and hand tools such as a wire brush are used to carry out work such as scrapping off rust by applying hand tools to places where rust has formed. However, rust removal of uneven places where hand tools are difficult to apply and narrow spaces where hand tools cannot reach is a problem, and expectations are rising in terms of non-contact rust removal technologies that use lasers.

### CITATION LIST

### Non Patent Literature

[NPL 1] “Social Issues that CoolLaser is Tackling” (in Japanese) [Online], Toyokoh Inc., Available at: https://www.toyokoh.com/images/data/coollaser_pamphlet_201807.pdf (accessed: 9 Dec. 2019).

### SUMMARY

### Technical Problem

In laser cleaning that uses a laser, cleaning to a clean state can be performed in a non-contact manner without the device or part of the device physically contacting the cleaning target. Laser cleaning is thus conceivably useful as a cleaning method that is able to realize treatment of narrow spaces where hand tools and the like cannot get into and surface cleaning unaffected by the uneven surface shapes of targets. However, with infrastructure facilities that are used outdoors in particular, removal of grime and rust on a steel material surface involves laser cleaning being used as surface pretreatment for performing coating that prevents facility degradation, but there is an issue in that the coating needs to be compatible with the degree of cleanliness of the steel material surface.

In the case of removing rust that has formed on a steel material surface with a laser emitted from a laser cleaning device, the surface appears to be in a clean state at a level recognizable by the human eye. However, as shown in FIG. 9, a very thin oxide layer of no more than several microns in thickness is known to form on the surface of steel materials due to the influence of heat that is produced when scanned laser light is absorbed. It was found that when coating is performed over the thin oxide layer formed due to laser cleaning, corrosion tends to occur in the case where moisture that penetrates the coating film comes in contact with the steel material surface, making it undesirable to use laser cleaning in coating pretreatment of steel material surfaces.

In this way, grime and rust on steel material surfaces can be removed with laser cleaning, but there is a problem in that an oxide layer is formed due to the cleaning, and corrosion occurs when coating is performed over this oxide layer.

In large-scale facilities such as infrastructure facilities, steel materials are generally used in order to ensure strength and keep costs down. In order for devices and facilities that utilize steel materials to be used securely and safely for a long time, deterioration of the steel materials needs to be inhibited, and coating is performed as a measure for achieving this. In performing coating on a steel material surface, the steel material surface is cleaned, but an oxide layer is formed on the steel material surface when laser cleaning is performed as aforementioned, with this being a problem. When coating is performed on the oxide layer that is formed, rust may occur between the coating film and the steel material surface as aforementioned. When rust occurs in this way, a problem arises in that the coating function becomes difficult to maintain, with occurrences such as cracks appearing in the coating film due to volume expansion caused by the rust and the coating film becoming readily separable.

Embodiments of the present invention have been made in order to solve problems such as the above, and an object of embodiments of the invention is to inhibit formation of an oxide layer on the surface of a steel material in laser cleaning of the steel material surface.

### Means for Solving the Problem

A cleaning method according to embodiments of the present invention includes a first step of emitting a first laser light toward a surface of a steel material and cleaning the surface of the steel material, and a second step of emitting a second laser light toward the surface of the steel material, after the first step, and removing an oxide layer formed on the surface of the steel material due to irradiation with the first laser light.

A cleaning device according to embodiments of the present invention includes a first laser source configured to output a first laser light at a power capable of removing rust on a surface of a steel material targeted for cleaning, a second laser source configured to output a second laser light at a lower power than the first laser light, a laser head configured to switch between the first laser light and the second laser light and emit laser light toward the surface of the steel material and to scan the emitted laser light, a first optical fiber configured to guide the first laser light emitted from the first laser source to the laser head, and a second optical fiber configured to guide the second laser light emitted from the second laser source to the laser head.

### Effects of Embodiments of the Invention

As described above, according to embodiments of the present invention, an oxide layer formed on the surface of a steel material due to irradiation with a first laser light is removed by emitting a second laser light toward the surface of the steel material, thus enabling formation of an oxide layer on the steel material surface in laser cleaning of the surface of the steel material to be inhibited.

### BRIEF DESCRIPTION OF THE DRAWINGS

FIG. 1 is a flowchart for describing a cleaning method according to an embodiment of the present invention.

FIG. 2 is a configuration diagram showing the configuration of a cleaning device according to the embodiment of the present invention.

FIG. 3A is a photograph showing the result of observing the surface of a steel material before cleaning, with a stereoscopic microscope.

FIG. 3B is a photograph showing the result of observing a cross-section of the steel material before cleaning, with a scanning electron microscope.

FIG. 4A is a photograph showing the result of observing the surface of an oxide layer formed on a steel material surface due to a first step, with a scanning electron microscope.

FIG. 4B is a photograph showing the result of observing a cross-section of the steel material in which the oxide layer is formed on the surface due to the first step, with a scanning electron microscope.

FIG. 5A is a photograph showing the result of observing the surface of a steel material after a second step, with a scanning electron microscope.

FIG. 5B is a photograph showing the result of observing a cross-section of the steel material after the second step, with a scanning electron microscope.

FIG. 5C is a photograph showing the result of observing a cross-section of the steel material after the second step, with a scanning electron microscope.

FIG. 6 is a configuration diagram showing the configuration of another cleaning device according to the embodiment of the present invention.

FIG. 7A is a descriptive diagram for describing the intensity distribution of a laser beam.

FIG. 7B is a descriptive diagram for describing the intensity distribution of a laser beam.

FIG. 8 is a configuration diagram showing the configuration of a conventional laser cleaning device.

FIG. 9 is a descriptive diagram for describing the state of laser cleaning.

### DETAILED DESCRIPTION OF ILLUSTRATIVE EMBODIMENTS

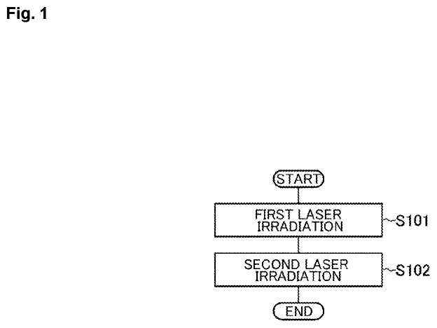

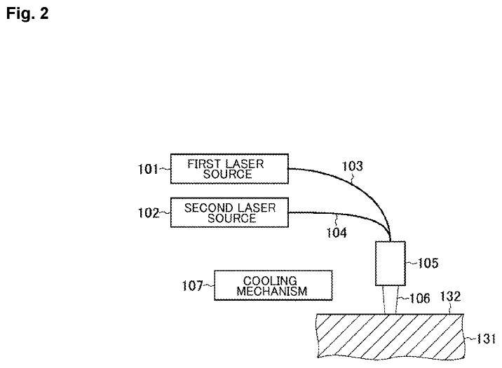

Hereinafter, a cleaning method according to an embodiment of the present invention will be described with reference to FIG. 1. This cleaning method involves, first, in a first step Sim, emitting a first laser light toward the surface of a steel material targeted for cleaning to clean the surface of the steel material. For example, a first laser light obtained by transforming pulsed laser light (or CW laser light) output from a laser source into a beam using a predetermined optical system is emitted toward the surface of the steel material targeted for cleaning. This treatment removes rust, grime and the like on the steel material surface. This step is similar to laser cleaning treatment that is generally implemented conventionally.

The first step requires a high laser output that is able to remove not only grime that can be easily removed but also rust that is not easy to remove. This laser output of the first laser light will be set to a high value. Thus, in the first step, an oxide layer occurs on the steel material surface.

Next, in a second step S102, a second laser light is emitted toward the surface of the steel material to remove the oxide layer formed on the surface of the steel material due to irradiation with the first laser light. In this step, the oxide layer formed on the surface of the steel material is removed, by emitting the second laser light at a power in a range that does not cause a new oxide layer to form on the surface of the steel material. For example, a second laser light obtained by transforming pulsed laser light (or CW laser light) output from the laser source into a beam using a predetermined optical system is emitted toward the surface of the steel material on which the oxide layer is formed due to the treatment of the first step.

Here, in the abovementioned first step, irradiation by the first laser light can be implemented in a state where the surface of the steel material has been cooled by being sprayed with gas or water. By placing the steel material surface targeted for cleaning in a predetermined temperature state through cooling, a state where the oxide layer is formed at a more uniform thickness can be achieved. Similarly, in the second step, irradiation by the second laser light can be implemented in a state where the surface of the steel material has been cooled by being sprayed with gas or water. In the second step, in particular, it is important to inhibit formation of a new oxide layer, and the abovementioned cooling is useful in order to inhibit formation of a new oxide layer, together with quickly removing the oxide layer that has already formed. For example, the surface of the steel material can be cooled by spraying the steel material surface with nitrogen gas at 23° C.

The second step can also be implemented after a set time period elapses after the first step. In this way, by implementing the second step after an interval of a set time period after the first step, the second step can be implemented after the surface of the steel material that is heated due to irradiation with the first laser light has been cooled. The set time period is determined as appropriate in conformance with the state of the steel material targeted for treatment.

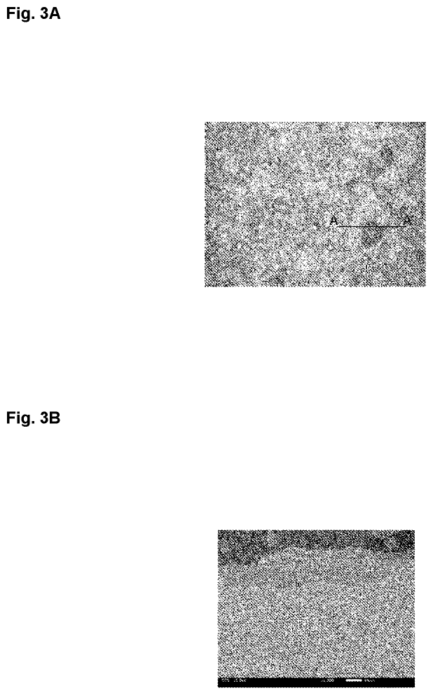

Next, a cleaning device according to the embodiment of the present invention will be described with reference to FIG. 3. This cleaning device is provided with a first laser source 101, a second laser source 102, a first optical fiber 103, a second optical fiber 104, and a laser head 105.

The first laser source 101 outputs a first laser light at a power capable of removing rust and grime on a surface 132 of a steel material 131 targeted for cleaning. The second laser source 102 outputs a second laser light at a lower power than the first laser light. The second laser source 102 outputs the second laser light at a power of a range that does not cause a new oxide layer to form on the surface 132 of the steel material 131. The first laser source 101 and the second laser source 102 can be constituted by a well-known pulsed laser device, for example. Also, the first laser source 101 and the second laser source 102 can be constituted by a CW laser device.

The first laser light emitted from the first laser source 101 is guided to the laser head 105 by the first optical fiber 103, and the second laser light emitted from the second laser source 102 is guided to the laser head 105 by the second optical fiber 104. The laser head 105 switches between the first laser light and the second laser light guided in this way to enable laser light to be emitted toward the surface 132 of the steel material 131. Also, the laser head 105 is able to scan a laser beam 106 that is emitted.

Also, this cleaning device is provided with a cooling mechanism 107 that sprays gas or water onto the surface 132 of the steel material 131 to cool the surface 132 of the steel material 131.

In large-scale facilities such as infrastructure facilities, steel materials are generally used in order to ensure strength and keep costs down. In order for devices and facilities that utilize steel materials to be used securely and safely for a long time, deterioration of the steel materials needs to be inhibited, and coating is performed as a measure for achieving this. An oxide layer is formed on the surface of the steel material when laser cleaning is performed on a steel material as aforementioned, and when rust occurs directly under the coating film due to performing coating over the oxide layer that is formed, a problem arises in that the coating function becomes difficult to maintain, with occurrences such as cracks appearing in the coating film due to volume expansion caused by the rust and the coating film becoming readily separable.

Cleaning of the steel material surface is realized by rust, grime and the like being burned off, vaporized and the like, due to absorption of laser light, regardless of differences in the local heat capacity caused by rust on the surface of the steel material and by dirt, dust, sand and the like adhering to the unevenness of the rust and differences in the materials that are exposed (differences in the absorption characteristics of the surface material). It was found that, since the output of the laser light is increased in order to efficiently clean the steel material surface, a layer of oxide is formed on the steel material surface after cleaning. Cracks appearing in the oxide layer that is formed was also confirmed.

The steel material surface heated to a high temperature due to irradiation with laser light is rapidly cooled when no longer irradiated with the laser light, and the difference in volumetric shrinkage rates due to the difference in the coefficients of linear expansion between the steel material and the oxide layer at this time is presumed to be the cause of the abovementioned cracking. The coating does not get into places where such cracking occurs, resulting in cavities being formed, and moisture that penetrates the coating film after the coating permeates into the cracked portions. When water permeates into the cracks in this way, water is interposed in the interface between the oxide layer and the steel material, resulting in an electric cell being formed, and there is concern that corrosion will occur due to the steel material beginning to melt. Accordingly, removal of the oxide layer is important in forming the coating film on steel materials.

In the treatment of the embodiment, by removing the oxide layer on the steel material surface in the second step, after removing grime, rust and the like on the steel material surface in the first step, the abovementioned problem of cracking of the oxide layer does not occur, as long as the oxide layer remaining on the surface of the steel material is eliminated. Also, if the oxide layer remaining on the surface of the steel material due to removal of the oxide layer is as thin as possible at around several nanometers in thickness, even if cracks appear, the cracks are filled by the resin of the coating film if coating is performed, since the cracks are very shallow. As a result, cavities are not formed in the cracked portions, and the abovementioned corrosion does not occur.

Next, the results of testing that implemented the cleaning method according to the embodiment will be described. First, FIG. 3A shows the result of observing the surface of the steel material before cleaning, with a stereoscopic microscope. Also, the result of observing a cross-section taken along line AA′ in FIG. 3A with a scanning electron microscope is shown in FIG. 3B. As shown in these diagrams, rust occurs on the surface of the steel material, and unevenness that reaches several tens of micrometers arises.

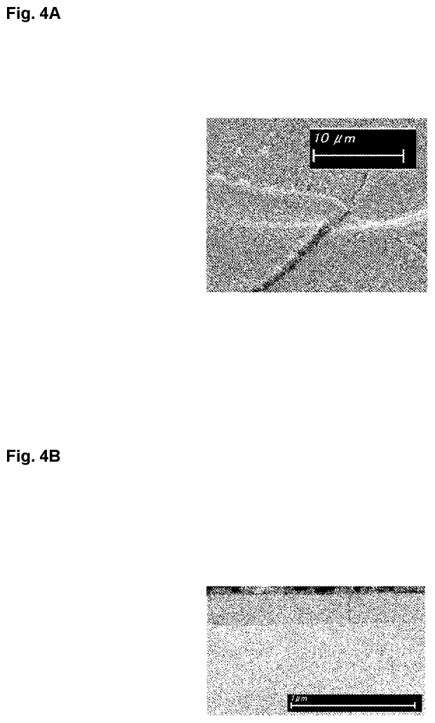

FIG. 4A shows the result of observing the surface of the oxide layer formed on the steel material surface due to the first step, with a scanning electron microscope. Also, the result of observing a cross-section taken along line AA′ in FIG. 4A with a scanning electron microscope is shown in FIG. 4B. Unevenness has occurred very severely on the surface of the oxide layer that is formed. It is evident that the steel material instantaneously melted by the laser irradiation solidifies as protuberances before being able to settle back into a smooth state. Also, as shown in FIG. 4B, it is confirmed that the oxide layer is formed comparatively thickly, and, furthermore, that cracking occurs in places.

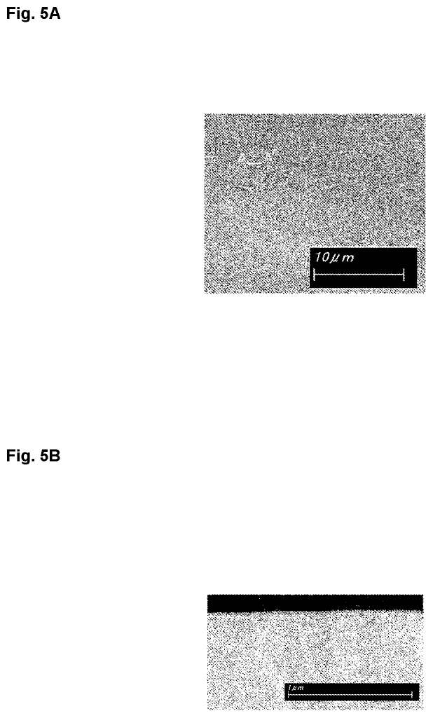

FIG. 5A shows the result of observing a state where the oxide layer formed on the surface of the steel material has been removed by the second step after the first step, with a scanning electron microscope. Also, the result of observing a cross-section taken along line AA′ in FIG. 5A with a scanning electron microscope is shown in FIG. 5B. The oxide layer is thin, and surface observation did not confirm cracking. It was confirmed that the oxide layer formed in the first step can be removed by the second step. Also, it was confirmed that, by controlling the output of the second laser light in the second step, it is possible to remove only the oxide layer formed in the first step, as shown in FIG. 5C. FIG. 5C shows the result of observing a cross-section of the steel material, with a scanning electron microscope.

Also, in the process of implementing the abovementioned testing, it was found that, in the cleaning, it is important for the temperature of the steel material surface targeted for cleaning before laser irradiation in each step to be controlled. In particular, formation of a new oxide layer on the steel material surface can be inhibited by the steel material surface being cooled through spraying with an inactive gas that does not contain oxygen such as N₂, prior to being irradiated with the second laser light, in the second step.

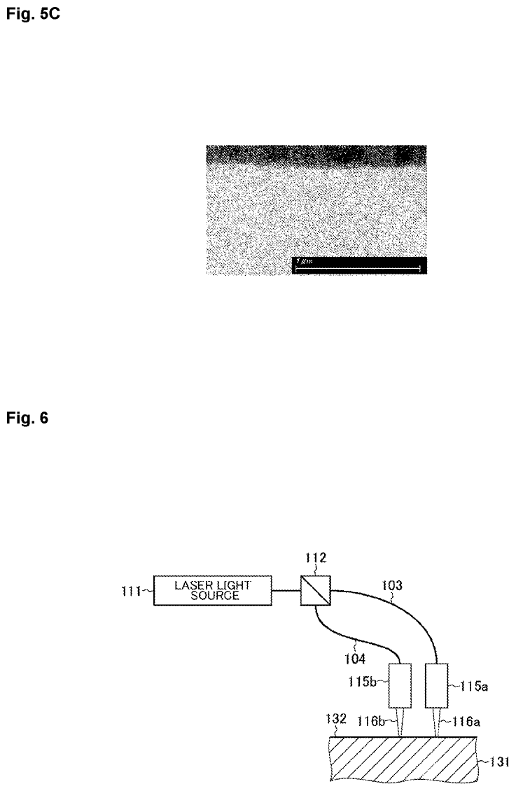

Next, another cleaning device according to the embodiment of the present invention will be described, with reference to FIG. 6. This cleaning device is provided with a laser light source in, a splitter 112, a first optical fiber 103, a second optical fiber 104, a first laser head 115a, and a second laser head 115b. The splitter 112 splits laser light output from the laser light source in into a first laser light that is transmitted and a second laser light that is reflected. The splitter 112 transmits 80% of incident laser light and reflects 20%, for example. Accordingly, the output of the second laser light will be a quarter of the output of the first laser light. These percentages are set as appropriate. The splitter 112 can be constituted by a polarizing beam splitter or a mirror, for example.

The first laser light split by the splitter 112 is guided to the first laser head 115a by the first optical fiber 103. The second laser light split by the splitter 112 is guided to the second laser head 115b by the second optical fiber 104. The first laser head 115a and the second laser head 115b are able to scan laser light that is emitted.

Testing was implemented by emitting the first laser light 116a from the first laser head 115a and emitting the second laser light 116b from the second laser head 115b, and scanning each laser head, while shifting the position of the steel material that is irradiated with each laser light and changing the irradiation timing of each laser light (laser beam). As a result, the oxide layer could be almost completely removed, together with being able to remove grime and rust, by irradiating the steel material surface with the second laser light 116b approximately 2 minutes after irradiation with the first laser light 116a. This cleaning device can be constituted by one laser light source in, and is advantageous for device cost reduction.

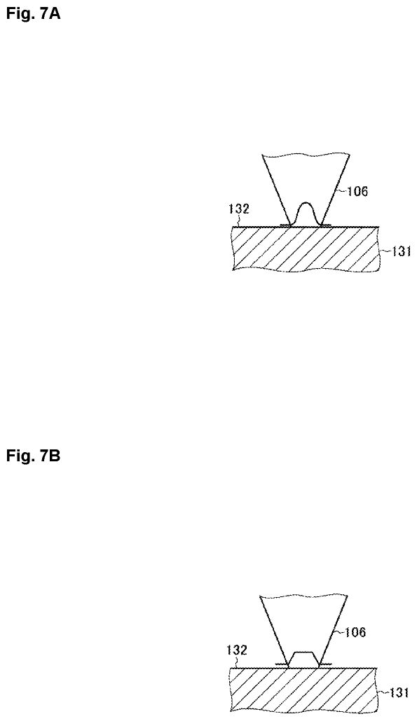

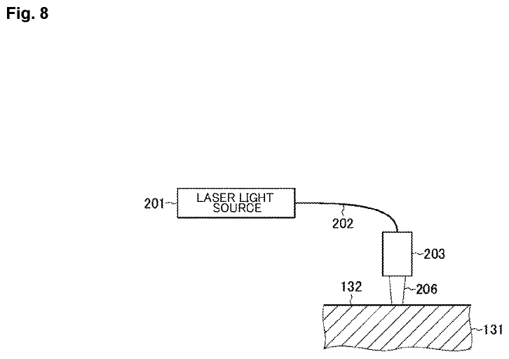

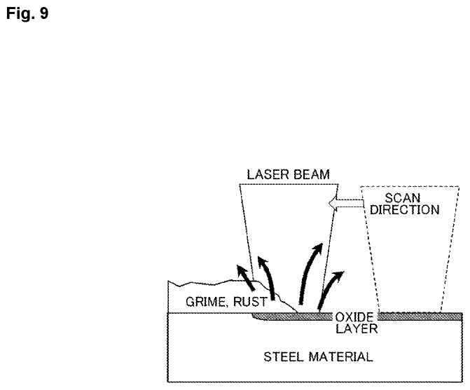

Incidentally, in order to enhance the temperature control accuracy of the irradiation position of the laser light, it is conceivable to perform laser beam pattern control. A normal laser beam exhibits a Gaussian distribution in which the intensity is strongest at the beam center and the intensity decreases toward the outer side of the beam in the beam diameter direction (FIG. 7A). In contrast, by control the intensity distribution of the beam as a whole, using a diffraction element or a combination of lenses in an optical system, a top hat distribution in which the intensity is substantially uniform in the beam diameter direction can be obtained (FIG. 7B).

By integrating a diffraction element or the like, for example, into the optical system of the laser head, and transforming the pattern of the laser beam into a top hat distribution such as mentioned above, it becomes possible for the thermal uniformity of the surface of the steel material irradiated with the laser beam to be enhanced, and the surface flatness after laser cleaning to be enhanced. Note that, in the abovementioned embodiment, an example is illustrated in which a diffraction element or the like is integrated to transform the pattern of the laser beam into a top hat distribution, but the present invention is not limited thereto. The pattern of the laser beam can be transformed into any shape, such as by creating a region having a high intensity distribution on the beam edge, with consideration for the fact that the temperature falls due to heat dissipation from the beam edge, for example.

As described above, according to embodiments of the present invention, the oxide layer formed on the surface of the steel material due to irradiation with the first laser light is removed by emitting the second laser light toward the surface of the steel material, thus enabling formation of an oxide layer on the surface of the steel material in laser cleaning of the surface of the steel material to be inhibited.

According to embodiments of the present invention, not only can rust and grime on the surface of a steel material be removed in a simple manner compared with conventional laser cleaning, but the minimization or removal of an oxide layer on the surface of the steel material caused by the influence of heat that occurs during laser cleaning can be realized, and characteristics that maintain long-term compatibility with the coating can be extracted. This is conceivably equivalent to surface treatment equivalent to type 2 surface preparation which is a steel material surface treatment similar to surface preparation work that uses blasting, power hand tools and the like such as used in conventional steel material surface treatment. Having coated each of the samples and implemented combined cycle testing in order to verify these results, the cleaning result that achieved the state shown in FIG. 5B confirmed that there is almost no deterioration in adhesive strength between the state prior to test implementation and the state after implementing 2000 hours of combined cycles.

Note that the present invention is not limited to the embodiments described above, and many modifications and combinations can clearly be implemented by those with ordinary knowledge in the relevant field, without departing from the technical concept of the invention.

### REFERENCE SIGNS LIST

101First laser source

102 Second laser source

103 First optical fiber

104 Second optical fiber

105 Laser head

106 Laser beam

107 Cooling mechanism

131 Steel material

132 Surface.

1-7. (canceled)

8. A cleaning method comprising:
a first step of emitting a first laser light toward a surface of a steel material and cleaning the surface of the steel material; and
after the first step, a second step of emitting a second laser light toward the surface of the steel material and removing an oxide layer formed on the surface of the steel material due to irradiation with the first laser light.

9. The cleaning method according to claim 8, wherein the second step is implemented after a set time period has elapsed after the first step.

10. The cleaning method according to claim 8, wherein:
the first step implements irradiation with the first laser light, in a state where the surface of the steel material has been cooled by being sprayed with gas or water; and
the second step implements irradiation with the second laser light, in a state where the surface of the steel material has been cooled by being sprayed with gas or water.

11. The cleaning method according to claim 8, wherein the gas does not comprise oxygen.

12. The cleaning method according to claim 8, wherein the second step removes the oxide layer formed on the surface of the steel material, by emitting the second laser light at a power in a range that does not cause a new oxide layer to form on the surface of the steel material.

13. The cleaning method according to claim 8, wherein the second laser light is emitted at a lower power than the first laser light.

14. A cleaning device comprising:
a first laser source configured to output a first laser light at a power capable of removing rust on a surface of a steel material targeted for cleaning;
a second laser source configured to output a second laser light at a lower power than the first laser light;
a laser head configured to switch between the first laser light and the second laser light, emit laser light toward the surface of the steel material, and to scan the emitted laser light;
a first optical fiber configured to guide the first laser light emitted from the first laser source to the laser head; and
a second optical fiber configured to guide the second laser light emitted from the second laser source to the laser head.

15. The cleaning device according to claim 14, further comprising:
a cooling mechanism configured to spray gas or water onto the surface of the steel material and cool the surface of the steel material.

16. The cleaning device according to claim 15, wherein the gas does not comprise oxygen.

17. The cleaning device according to claim 14, wherein the second laser source outputs the second laser light at a power in a range that does not cause a new oxide layer to form on the surface of the steel material.
